(19) United States
(12) Patent Application Publication
(10) Pub. No.: US 2024/0276194 A1
(43) Pub. Date: Aug. 15, 2024

(54) RESTRICTED SERVICE PROCESSING METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Jiangsheng FAN, Dongguan (CN)

(21) Appl. No.: 18/648,929

(22) Filed: Apr. 29, 2024

Related U.S. Application Data
(63) Continuation of application No. PCT/CN2021/127972, filed on Nov. 1, 2021.

(51) Int. Cl. H04W 4/90; H04W 8/22

(52) U.S. Cl. CPC H04W 4/90; H04W 8/22

(57) ABSTRACT

The present application relates to a restricted service processing method, a terminal device, a network device, a chip, a computer-readable storage medium, a computer program product, a computer program and a communication system. The method includes: a terminal device determines, on the basis of a network type supported by a cell, whether to use a restricted service provided by the cell, wherein the terminal device includes a first terminal device which supports an NPN function but is not in an SNPN mode, and/or a second terminal device which does not support the NPN function.

### CROSS-REFERENCE TO RELATED APPLICATION

This is a continuation application of International Patent Application No. PCT/CN2021/127972, filed on Nov. 1, 2021, entitled “RESTRICTED SERVICE PROCESSING METHOD, TERMINAL DEVICE, AND NETWORK DEVICE”, the disclosure of which is hereby incorporated by reference in its entirety.

### BACKGROUND

In order to meet dedicated network requirements for the vertical industry, a Non-public Network (NPN) is introduced into the 5th-Generation (5G) communication. In order to increase the flexibility of the NPN network deployment, the NPN may be divided into a Stand-alone Non-public Network (SNPN) and a Closed Access Group (CAG) network. It is necessary to consider how to control a terminal device to receive restricted services after introducing the NPN.

### SUMMARY

The present disclosure relates to the field of communications, and more particularly to a method for processing a restricted service, a terminal device, a network device, a chip, a computer-readable storage medium, a computer program product, a computer program and a communication system.

An embodiment of the present disclosure provides a method for processing a restricted service, including an operation as follows.

A terminal device determines whether to use the restricted service provided by a cell based on a network type supported by the cell.

The terminal device includes a first terminal device that supports a NPN function but is not in a SNPN mode, and/or a second terminal device that does not support the NPN function.

An embodiment of the present disclosure further provides a terminal device, including a processor and a memory for storing a computer program. The processor calls and runs the computer program stored in the memory to:

determine whether to use a restricted service provided by a cell based on a network type supported by the cell.

The terminal device includes a first terminal device that supports a NPN function but is not in a SNPN mode, and/or a second terminal device that does not support the NPN function.

An embodiment of the present disclosure further provides a network device, including a processor and a memory for storing a computer program. The processor calls and runs the computer program stored in the memory to:

transmit first indication information to a terminal device, the first indication information is used for indicating the terminal device to determine whether a preset condition is satisfied, the preset condition is used for the terminal device to determine whether it is incapable of using a restricted service in a cell in a case that the cell supports a SNPN; and wherein the terminal device includes a first terminal device that supports a NPN function but is not in a SNPN mode, and/or a second terminal device that does not support the NPN function.

### BRIEF DESCRIPTION OF THE DRAWINGS

FIG. 1 is a schematic diagram of a communication system architecture according to an embodiment of the present disclosure.

FIG. 2 is a schematic flowchart of a method for processing a restricted service according to an embodiment of the present disclosure.

FIG. 3 is a schematic flowchart of a method for processing a restricted service according to another embodiment of the present disclosure.

FIG. 4 is a schematic flowchart of a method for processing a restricted service according to yet another embodiment of the present disclosure.

FIG. 5 is a schematic structural block diagram of a terminal device according to an embodiment of the present disclosure.

FIG. 6 is a schematic structural block diagram of a terminal device according to another embodiment of the present disclosure.

FIG. 7 is a schematic structural block diagram of a network device according to an embodiment of the present disclosure.

FIG. 8 is a schematic structural block diagram of a network device according to another embodiment of the present disclosure.

FIG. 9 is a schematic block diagram of a communication device according to an embodiment of the present disclosure.

FIG. 10 is a schematic block diagram of a chip according to an embodiment of the present disclosure.

FIG. 11 is a schematic block diagram of a communication system according to an embodiment of the present disclosure.

### DETAILED DESCRIPTION

The technical solution in embodiments of the present disclosure will be described below in combination with the drawings in the embodiments of the present disclosure.

The technical solution in embodiments of the present disclosure can be applied to various communication systems, such as a Global System of Mobile communication (GSM) system, a Code Division Multiple Access (CDMA) system, a Wideband Code Division Multiple Access (WCDMA) system, a General Packet Radio Service (GPRS) system, a Long Term Evolution (LTE) system, an Advanced Long Term Evolution (LTE-A) system, a New Radio (NR) system, an evolution system of the NR system, a LTE-based access to unlicensed spectrum (LTE-U) system, a NR-based access to unlicensed spectrum (NR-U) system, a Non-Terrestrial Network (NTN) system, a Universal Mobile Telecommunications System (UMTS), a Wireless Local Area Network (WLAN), a Wireless Fidelity (WiFi), a 5th Generation (5G) system or other communication systems.

In general, traditional communication systems support a limited number of connections and are easy to implement. However, with the development of the communication technologies, mobile communication systems will not only support traditional communication, but also support, for example, Device to Device (D2D) communication, Machine to Machine (M2M) communication, Machine Type Communication (MTC), Vehicle to Vehicle (V2V) communication, or Vehicle to everything (V2X) etc. The embodiments of the present disclosure can also be applied to these communication systems.

Optionally, the communication systems in the embodiments of the present disclosure may be applied to Carrier Aggregation (CA) scenarios, Dual Connectivity (DC) scenarios, or Standalone (SA) network deployment scenarios.

Each embodiment is described in connection with a network device and a terminal device in the embodiments of the present disclosure. The terminal device may also be referred to as a User Equipment (UE), an access terminal, a user unit, a user station, a mobile station, a remote station, a remote terminal, a mobile device, a user terminal, a terminal, a wireless communication device, a user agent or a user apparatus, etc.

The terminal device may be a station (ST) in the WLAN, a cellular telephone, a cordless telephone, a Session Initiation Protocol (SIP) telephone, a Wireless Local Loop (WLL) station, a Personal Digital Processing (PDA) device, a handheld device having a wireless communication function, a computing device or other processing devices connected to a wireless modem, an on-board equipment, a wearable device, a next generation communication system, such as a terminal device in an NR network, or a terminal device in a future evolved Public Land Mobile Network (PLMN), etc.

In the embodiments of the present disclosure, the terminal device may be arranged on land including indoor or outdoor areas, handheld, wearable or on-board. The terminal device may also be arranged on the water (such as on a ship). The terminal device may further be arranged in the air (such as on an airplane, a balloon, or a satellite).

In the embodiments of the present disclosure, the terminal device may be a mobile phone, a tablet computer (or Pad), a computer with wireless transceiver function, a Virtual Reality (VR) terminal device, an Augmented Reality (AR) terminal device, a wireless terminal device in industrial control, a wireless terminal device in self driving, a wireless terminal device in remote medical, a wireless terminal device in a smart grid, a wireless terminal device in transportation safety, a wireless terminal device in a smart city, or a wireless terminal device in a smart home, etc.

As an example rather than a limitation, in the embodiments of the present disclosure, the terminal device may also be a wearable device. The wearable device may also be referred to as a wearable intelligent device, which is a general name of the wearable devices developed by intelligently designing for the daily wears with a wearable technology, such as glasses, gloves, watches, clothing and shoes. The wearable device is a portable device that is worn directly on the body or integrated into the user's clothes or accessories. The wearable device is not only a hardware device, but also a device realizing powerful functions through software support, data interaction and cloud interaction. Generalized wearable intelligent devices include: a device (such as intelligent watches or intelligent glasses) with full functions and large size, which can implement complete or partial functions without relying on an intelligent phone, and a device (such as various intelligent bracelets and intelligent jewelries for monitoring physical signs) which only focuses on a certain application function, and is used in conjunction with other devices (such as smart phone).

In the embodiments of the present disclosure, the network device may be a device for communicating with a mobile device, and the network device may be an Access Point (AP) in the WLAN, a Base Transceiver Station (BTS) in the GSM or CDMA, a NodeB (NB) in the WCDMA, an Evolutional Node B (eNB or eNodeB) in the LTE, a relay station or an AP, an on-board equipment or a wearable device, an network device or gNB in an NR network or an network device in a future evolved PLMN network.

The network device may also be a core network device, such as a Mobility Management Entity (MME), an Access and Mobility Management Function (AMF) and other network entities, which is not limited in embodiments of the present disclosure.

As an example rather than a limitation, in the embodiments of the present disclosure, the network device may have mobility, for example, the network device may be a mobile device. Optionally, the network device may be a satellite or a balloon station. For example, the satellite may be a Low Earth Orbit (LEO) satellite, a Medium Earth Orbit (MEO) satellite, a Geostationary Earth Orbit (GEO) satellite, a High Elliptical Orbit (HEO) satellite, or the like. Optionally, the network device may also be a base station arranged on land, on the water and the like.

In the embodiments of the present disclosure, the network device may provide services for a cell, and the terminal device communicates with the network device through the transmission resources (such as frequency domain resources, also called spectrum resources) used by the cell. The cell may be a cell corresponding to the network device (e.g., the base station), and the cell may belong to a macro base station or a base station corresponding to a small cell. The small cell may include a metro cell, a micro cell, a pico cell, a femto cell, etc. These small cells have characteristics of small coverage and low transmission power, which are suitable for providing services of high-speed data transmission.

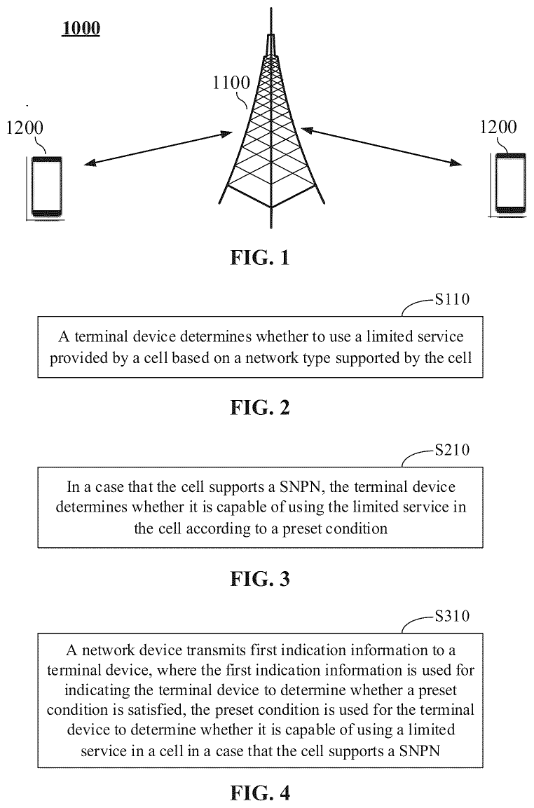

FIG. 1 schematically illustrates a wireless access system 1000 including one network device 1100 and two terminal devices 1200. Optionally, the wireless communication system 1000 may include a plurality of network devices 1100, and other numbers of terminal devices may be included within the coverage area of each network device 1100, which is not limited in embodiments of the present disclosure.

It should be understood that a device having a communication function in a network/system in the embodiments of the present disclosure may be referred to as a communication device. The communication system illustrated in FIG. 1 is taken as an example, the communication device may include a network device and a terminal device having communication functions, the network device and the terminal device may be specific devices in the embodiments of the present disclosure and will not be elaborated herein.

It should be understood that terms “system” and “network” in the present disclosure may usually be exchanged. In the present disclosure, the term “and/or” is only used for describing an association relationship of associated objects, for example, the term “and/or” represents that three relationships may exist between previous and next associated objects. For example, A and/or B may represent three conditions: independent existence of A, existence of both A and B, and independent existence of B. Character “/” in the present disclosure usually represents that an “or” relationship is formed between the previous and next associated objects.

It should be understood that the “indication” mentioned in the embodiments of the present disclosure may be a direct indication, may be an indirect indication, or may represent an association relationship. For example, A indicating B may represent that A directly indicates B, e.g., B can be obtained through A, may also represent that A indirectly indicates B, e.g., A indicates C, and B can be obtained through C, or may also represent that there is an association relationship between A and B.

In the description of the embodiments of the disclosure, the term “corresponding to” may represent that there is a direct correspondence or an indirect correspondence relationship between two elements, may also represent that there is an association relationship between the two elements, or may also be a relationship of indicating and being indicated, or configuration and being configured, etc.

In order to facilitate the understanding of the technical solution of the embodiments of the present disclosure, the related technologies of the embodiments of the present disclosure are described below. The following related technologies, as optional schemes, may be arbitrarily combined with the technical solutions of the embodiments of the present disclosure, all of which belong to the scope of protection of the embodiments of the present disclosure.

### (1) NR NPN Network Deployment Schematic

The NPN network is introduced into NR R16. In order to increase the flexibility of the NPN network deployment, the NPN network may be divided into a SNPN and a CAG network. Exemplarily, an SNPN network may be identified by a combination of a Public Land Mobile Network (PLMN) Identifier (ID) and a Network Identifier (NID) (i.e., PLMN ID+NID). A CAG network may also be identified by a combination of a PLMN ID and a CAG ID (i.e., PLMN ID+CAG ID).

One PLMN may simultaneously support any network sharing combination mode of a common public network, a SNPN and a CAG network. For example, one PLMN may independently support the common public network or the SNPN or the CAG network, and the common public network and the SNPN may also share one PLMN. Further, it is allowed that the common public network, the SNPN and the CAG network are simultaneously associated with one PLMN. The logical deployment relationship among the common public network, the SNPN and the CAG network may be more clearly reflected in Table 1 below.

TABLE 1
schematic network identifier configuration that may be supported by a cell

| Network identifier | Public network | PLMN ID 1 | |
|---|---|---|---|
| information | PLMN ID list | PLMN ID 2 | |
| broadcasted by a cell | information | . . . | |
| | | PLMN ID N | |
| | Non-public network | PLMN ID N + 1 | CAG ID list 1 |
| | NPN network | PLMN ID N + 2 | CAG ID list 2 |
| | identifier list | . . . | . . . |
| | information | PLMN ID N + M | CAG ID list M |
| | (optional) | PLMN ID N + M + 1 | NID list 1 |
| | | PLMN ID N + M + 2 | NID list 2 |
| | | . . . | . . . |
| | | PLMN ID N + M + W | NID list W |

The parameter N/M/W is a positive integer greater than or equal to 1.

As shown in Table 1, from the perspective of the network configuration, one cell may simultaneously configure public network PLMN ID list information and non-public network NPN network identifier list information, but the non-public network NPN network identifier list information is an optional parameter introduced by NR R16. For the NPN network with a CAG type, one PLMN ID is allowed to be associated with one CAG ID list. For the NPN network with an SNPN type, one PLMN ID is allowed to be associated with one NID list.

### (2) Restricted Service

A restricted service includes a Public Warning System (PWS) service and/or an emergency communication service. The two types of services are described as follows.

PWS service: the PWS is mainly used to provide various warning messages, such as an earthquake and tsunami warning message or a commercial warning message, for the terminal device. The terminal device determines whether the network device is ready to transmit the PWS message by receiving a PWS indication bit contained in the paging short message transmitted by the network device. For the PLMN, the network device supports the transmitting of the PWS-related messages by default, and the terminal device determines whether it is necessary to receive the PWS-related messages according to PWS support capability information of the terminal device.

Emergency communication service: at present, for the PLMN network, the network will inform the terminal whether the cell supports the emergency communication service through system broadcast messages, and the terminal may only initiate the emergency communication service in the cell that supports the emergency communication service.

For the SNPN network, the emergency communication and PWS functions are not supported in NR R16 version, and in R17 version, the emergency communication and PWS functions are supported after enhancing the SNPN network. However, it is necessary to consider how to control various types of terminals to receive the emergency communication service and/or the PWS service.

The solutions provided by the embodiments of the present disclosure are mainly used for solving at least one of the above problems.

In order to enable a more detailed understanding of the features and technical contents of the embodiments of the present disclosure, the implementations of the embodiments of the present disclosure will be described in detail below in conjunction with the accompanying drawings. The accompanying drawings are provided for illustration only and are not intended to limit the embodiments of the present disclosure.

FIG. 2 is a schematic flowchart of a method for processing a restricted service according to an embodiment of the present disclosure. The method optionally may be applied to the system illustrated in FIG. 1, but is not limited thereto. The method includes following operation S110.

At S110, a terminal device determines whether to use the restricted service provided by a cell based on a network type supported by the cell.

The terminal device includes a first terminal device that supports a NPN function but is not in a SNPN mode, and/or a second terminal device that does not support the NPN function.

Supporting the NPN function includes any one of the following meanings: only supporting the SNPN function, only supporting the CAG function or simultaneously supporting the SNPN function and the CAG function.

It will be understood that, in the embodiments of the present disclosure, the terminal device performing the above method may be the terminal device with the specific type including, but not limited to, a terminal device that supports a NPN function but is not in a SNPN mode, and/or a terminal device that does not support the NPN function. Further, in the embodiments of the present disclosure, the first terminal device may refer to the terminal device that supports the NPN function but is not in the SNPN mode, and the second terminal device may refer to the terminal device that does not support the NPN function.

In the embodiments of the present disclosure, using the restricted service provided by the cell may also be understood as accepting the restricted service provided by the cell. Exemplarily, the restricted service provided by the cell includes the emergency communication service and/or the PWS service. Accordingly, accepting the restricted service provided by the cell may include that initiating the emergency communication service (i.e., transmitting an emergency communication service message) in the cell, or including that accepting the PWS service (i.e., receiving a PWS service message), or simultaneously including that initiating the emergency communication service and accepting the PWS service.

As an optional embodiment, operation S110 that the terminal device determines whether to use the restricted service provided by the cell based on the network type supported by the cell includes that: in a case that the cell supports a SNPN, the terminal device determines that it is incapable of using the restricted service in the cell. That is to say, for the first terminal device that supports the NPN function but is not in the SNPN mode, and/or the second terminal device that does not support the NPN function, if the cell supports the SNPN, the terminal device cannot accept the restricted service in the cell.

Specifically, in a case that the cell supports a SNPN, the terminal device determining that it is incapable of using the restricted service in the cell may include that:

in a case that the cell supports the SNPN, the terminal device determines that it is incapable of transmitting an emergency communication service message in the cell;

and/or

in a case that the cell supports the SNPN, the terminal device determines that it is incapable of receiving the PWS service message in the cell.

Exemplarily, the case that the cell supports the SNPN may include a case that the cell only supports the SNPN and/or a case that the cell supports the SNPN while supporting other types of networks, such as the public network. It should be noted that in some embodiments of the present disclosure, the case that the cell supports the SNPN may refer specifically to the case that the cell only supports the SNPN.

As another optional embodiment, referring to FIG. 3, operation S110 that the terminal device determines whether to use the restricted service provided by the cell based on the network type supported by the cell may include following operation S210.

At S210, in a case that the cell supports the SNPN, the terminal device determines whether it is capable of using the restricted service in the cell according to a preset condition. That is to say, the first terminal device that supports a NPN function but is not in the SNPN mode and/or the second terminal device that does not support the NPN function may determine whether it is capable of using the restricted service in the cell based on the network type in conjunction with the preset condition.

For the PWS service, the terminal device determining whether to use the restricted service provided by the cell based on the network type supported by the cell may include that: in a case that the cell supports a SNPN, the terminal device determines whether it is capable of transmitting an emergency communication service message in the cell according to the preset condition.

Optionally, the terminal device determining whether it is capable of transmitting the emergency communication service message in the cell according to the preset condition may include that: in a case that a first condition is satisfied, the first terminal device determines that it is capable of transmitting the emergency communication service message in the cell.

Optionally, the first condition may include that: first indication information indicates that a current cell is not reserved for other usages; and at least one SNPN supported by the cell supports an emergency communication service. That is to say, it is at least necessary for the first terminal device that supports a NPN function but is not in the SNPN mode to initiate the emergency communication service in a case that the first indication information indicates that the current cell is not reserved for other usages and the at least one SNPN supported by the cell supports the emergency communication service.

Exemplarily, the aforementioned other usages include the NPN service. When the first indication information indicates that the current cell is reserved for other usages, i.e., the current cell is used for the NPN, the first terminal device is not allowed to reside in the cell, i.e., the first terminal device is prohibited from accepting any service in the cell. Thus, the first condition at least includes that first indication information indicates that the current cell is not reserved for other usages.

Optionally, the first indication information may be configured by a cell system broadcast message.

Optionally, the first condition may further include that: third indication information indicates that the first terminal device is allowed to transmit the emergency communication service message through a SNPN. That is to say, it is at least necessary for the first terminal device that supports a NPN function but is not in the SNPN mode to initiate the emergency communication service in a case that the first indication information indicates that the current cell is not reserved for other usages, the at least one SNPN supported by the cell supports the emergency communication service and the third indication information indicates that the first terminal device is allowed to transmit the emergency communication service message through the SNPN.

Optionally, the third indication information may be configured by a cell system broadcast message.

In various optional embodiments for the emergency communication service described above, the terminal device determining whether it is capable of transmitting the emergency communication service message in the cell according to the preset condition may include at least one of following operations.

In a case that a first condition is satisfied, the second terminal device determines that it is incapable of transmitting the emergency communication service message in the cell.

In a case that a second condition is satisfied, the second terminal device determines that it is capable of transmitting the emergency communication service message in the cell.

In a case that the first condition is satisfied, the second terminal device determines that it is capable of transmitting the emergency communication service message in the cell.

For example, in a case that the first condition is satisfied, the first terminal device may initiate the emergency communication service, but the second terminal device cannot initiate the emergency communication service.

For another example, in a case that the first condition is satisfied, the first terminal device may initiate the emergency communication service. In a case that another condition, i.e., a second condition, is satisfied, the second terminal device may initiate the emergency communication service. The second condition may include that: first indication information indicates that a current cell is not reserved for other usages; at least one SNPN supported by the cell supports an emergency communication service; and second indication information indicates that the second terminal device is allowed to transmit the emergency communication service message through the SNPN (i.e., the terminal device that does not support the NPN function is allowed to transmit the emergency communication service message).

For another example, in a case that the first condition is satisfied, both the first terminal device and the second terminal device may initiate the emergency communication service.

For the PWS service, exemplarily, a terminal device with a specific type is also capable of accepting the PWS service when the terminal device with the specific type is capable of residing in the cell (e.g., when it is capable of initiating the emergency communication service). That is to say, the method further includes that: the terminal device receives a PWS service message in the cell in a case that the terminal device is capable of transmitting the emergency communication service message in the cell.

Alternatively, the terminal device determining whether to use the restricted service provided by the cell based on the network type supported by the cell may include that: in the case that the cell supports the SNPN, the terminal device determines whether it is capable of receiving the PWS service message in the cell according to the preset condition. That is to say, for the PWS service, the aforementioned method used to determine that whether it is capable of using the restricted service by combining the network type and the preset condition may also be adopted.

Optionally, the terminal device determining whether it is capable of receiving the PWS service message in the cell according to the preset condition includes that: in a case that a third condition is satisfied, the first terminal device determines that it is capable of receiving the PWS service message in the cell.

Exemplarily, the third condition includes that first indication information indicates that a current cell is not reserved for other usages. That is, when the current cell is not reserved for other usages, such as the NPN service, the first terminal device may reside in the cell, and the first terminal device may receive the PWS service in the cell.

Exemplarily, the third condition may include that the first indication information indicates that the current cell is not reserved for other usages, and the third indication information indicates that the first terminal device is allowed to receive the PWS service message through the SNPN. That is, when the current cell is not reserved for other usages and the third indication information indicates that the first terminal device is allowed to receive the PWS service message through the SNPN, the first terminal device may accept the PWS service in the cell.

Exemplarily, the third condition may further include that at least one SNPN supported by the cell supports the PWS service. For example, when the current cell is not reserved for other usages and the at least one SNPN supported by the cell supports the PWS service, the first terminal device may receive the PWS service in the cell. For another example, when the current cell is not reserved for other usages, the at least one SNPN supported by the cell supports the PWS service and the third indication information indicates that the first terminal device is allowed to receive the PWS service message through the SNPN, the first terminal device may accept the PWS service in the cell.

Optionally, in various optional embodiments for the PWS service described above, the terminal device determining whether it is capable of receiving the PWS service message in the cell according to the preset condition includes at least one of following operations.

In a case that a third condition is satisfied, the second terminal device determines that it is incapable of receiving the PWS service message in the cell.

In a case that a fourth condition is satisfied, the second terminal device determines that it is capable of receiving the PWS service message in the cell.

In a case that the third condition is satisfied, the second terminal device determines that it is capable of receiving the PWS service message in the cell.

For example, in a case that the third condition is satisfied, the first terminal device may accept the PWS service in the cell, but the second terminal device cannot accept the PWS service in the cell.

For another example, in a case that the third condition is satisfied, the first terminal device may accept the PWS service in the cell; in a case that another condition, i.e., the fourth condition, is satisfied, the second terminal device may accept the PWS service in the cell. The fourth condition may include that: first indication information indicates that the current cell is not reserved for other usages; and second indication information indicates that the second terminal device is allowed to receive the PWS service message through the SNPN. Optionally, the fourth condition may further include that: at least one SNPN supported by the cell supports the PWS service.

For another example, in a case that the third condition is satisfied, both the first terminal device and the second terminal device may accept the PWS service in the cell.

Optionally, a manner that the terminal device knows whether the at least one SNPN supported by the cell supports the restricted service, such as the emergency communication service and/or the PWS service, may be that: the terminal device knows from a cell system broadcast message or through historical storage information of the terminal device. That is, the method may further include that: the terminal device determines whether at least one SNPN supported by the cell supports the restricted service according to the received cell system broadcast message and/or the historical storage information of the terminal device.

Optionally, a manner that the terminal device knows whether the at least one SNPN supported by the cell supports the restricted service, such as the emergency communication service and/or the PWS service, may also be that the terminal device knows the information by attempting to use the restricted service. For example, the above method may include that:

the terminal device determines whether at least one SNPN supported by the cell supports the emergency communication service by executing a registration process of the emergency communication service;

and/or

the terminal device determines whether the at least one SNPN supported by the cell supports the PWS service by monitoring PWS update indication information.

Corresponding to the above method, an embodiment of the present disclosure further provides a method for processing the restricted service, and the method can be performed by a network device. Referring to FIG. 4, the method includes following operation S310.

At S310, the network device transmits first indication information to a terminal device, the first indication information is used for indicating the terminal device to determine whether a preset condition is satisfied, the preset condition is used for the terminal device to determine whether it is capable of using the restricted service in a cell in a case that the cell supports a SNPN, and the terminal device includes a first terminal device that supports a NPN function but is not in a SNPN mode, and/or a second terminal device that does not support the NPN function.

Optionally, the first indication information is carried by a cell system broadcast message.

Optionally, the first indication information is used for indicating whether a current cell is reserved for other usages. Exemplarily, the first indication information may be used to determine at least one of the aforementioned first condition, second condition, third condition or fourth condition.

Optionally, the first indication information is used for indicating the first terminal device to determine whether the first condition and/or the third condition are/is satisfied.

The first condition is used for the first terminal device to determine whether it is capable of transmitting an emergency communication service message in the cell in a case that the cell supports the SNPN. The third condition is used for the first terminal device to determine whether it is capable of receiving a PWS service message in the cell in a case that the cell supports the SNPN.

Exemplarily, the first condition and/or the third condition may include that first indication information indicates that the current cell is not reserved for other usages. Further, optionally but not being limited, the first condition may further include that at least one SNPN supported by the cell supports the emergency communication service, and the third condition may further include that at least one SNPN supported by the cell supports the PWS service.

Optionally, the method may further include following operation.

The network device transmits third indication information to the first terminal device, and the third indication information is used for indicating the first terminal device to determine whether the first condition and/or the third condition are/is satisfied.

The third indication information may be carried by a cell system broadcast message.

That is to say, whether the first condition and/or the third condition are/is satisfied may be determined based on a combination of the first indication information and the third indication information. For example, the first condition may further include that the third indication information indicates that the first terminal device is allowed to transmit the emergency communication service message through the SNPN. The third condition may further include that the third indication information indicates that the first terminal device is allowed to receive the PWS service message through the SNPN.

Optionally, the first indication information may be used for indicating the second terminal device to determine whether the first condition and/or the third condition are/is satisfied.

The first condition is used for the second terminal device to determine whether it is capable of transmitting an emergency communication service message in the cell in a case that the cell supports the SNPN. The third condition is used for the second terminal device to determine whether it is capable of receiving a PWS service message in the cell in a case that the cell supports the SNPN.

That is to say, the second terminal device may also adopt a method similar to that of the first terminal device to determine whether the first condition and/or the third condition are/is satisfied based on the first indication information, and use the restricted service if satisfied.

Optionally, the method further includes following operation.

The network device transmits second indication information to the second terminal device, and the second indication information is used for indicating the second terminal device to determine whether a second condition and/or a fourth condition are/is satisfied.

The second condition is used for the second terminal device to determine whether it is capable of transmitting an emergency communication service message in the cell in a case that the cell supports the SNPN. The fourth condition is used for the second terminal device to determine it is capable of receiving a PWS service message in the cell in a case that the cell supports the SNPN.

The second indication information may be carried by a cell system broadcast message.

Exemplarily, the second indication information is used for indicating whether the second terminal device is allowed to use the restricted service through the SNPN.

Exemplarily, whether the second condition and/or the fourth condition are/is satisfied may be determined based on a combination of the first indication information and the second indication information.

For example, the second condition may include that the first indication information indicates that the current cell is not reserved for other usages and the second indication information indicates that the second terminal device is allowed to transmit the emergency communication service message through the SNPN.

As another example, the fourth condition may include that the first indication information indicates that the current cell is not reserved for other usages and the second indication information indicates that the second terminal device is allowed to receive the PWS service message through the SNPN.

Further, optionally but not being limited, the second condition may further include that at least one SNPN supported by the cell supports the emergency communication service, and the fourth condition may further include that at least one SNPN supported by the cell supports the PWS service. Optionally, indication information of whether the at least one SNPN supported by the cell supports the PWS service may also be carried and transmitted by the cell system broadcast message.

It can be understood that the network device can transmit the indication information through the cell system broadcast message, for the terminal device to determine whether the preset condition is satisfied, and determines whether to use the restricted service according to different cases. The conditions corresponding to each piece of indication information and the processing by the terminal device with respect to each condition can be realized with reference to the aforementioned embodiments and will not be elaborated herein.

Specific examples are provided below to illustrate how the first terminal device that supports the NPN function but is not in the SNPN mode and the second terminal device that does not support the NPN function respectively determine whether it is capable of using the restricted service in a case that the cell only supports the SNPN.

### First Example

In this example, it mainly controls the conditions under which the terminal device accepts the emergency communication service. On this basis, the PWS service is a subordinate service, i.e., whether to accept the PWS service can be determined based on whether to accept the emergency communication service.

The manner of controlling the terminal device to accept the emergency communication service includes any one of the following manners.

First manner: Neither the first terminal device nor the second terminal device can initiate the emergency communication service.

That is, both the terminal device that supports the NPN function but is not in the SNPN mode and the terminal device that does not support the NPN function cannot initiate the emergency communication service through any SNPN network.

Second manner: in a case that the first condition is satisfied, the first terminal device can initiate the emergency communication service, but the second terminal device cannot initiate the emergency communication service. The first condition includes that the first indication information configured by the cell system broadcast message is set to a value of “false” and at least one SNPN supported by the cell supports the emergency communication service.

That is to say, the terminal device that supports the NPN function but is not in the SNPN mode can reside in the SNPN cell and initiate the emergency communication service in a case that the first condition is satisfied. The terminal device that does not support the NPN function cannot initiate the emergency communication services through any SNPN network.

Third manner: in a case that the first condition is satisfied, the first terminal device can initiate the emergency communication service; in a case that the second condition is satisfied, the second terminal device can initiate the emergency communication service.

The first condition includes that the first indication information configured by the cell system broadcast message is set to a value of “false” and at least one SNPN supported by the cell supports the emergency communication service.

The second condition includes that the first indication information configured by the cell system broadcast message is set to a value of “false”, at least one SNPN supported by the cell supports the emergency communication service, and the second indication information configured by the cell system broadcast message allows the terminal device that does not support the NPN function to initiate the emergency communication service through the SNPN.

That is to say, the terminal device that supports the NPN function but is not in the SNPN mode can reside in the SNPN cell and initiate the emergency communication service in a case that the first condition is satisfied. The terminal device that does not support the NPN function can reside in the SNPN cell and initiate the emergency communication service in a case that the second condition is satisfied.

Fourth manner: in a case that the first condition is satisfied, both the first terminal device and the second terminal device can initiate the emergency communication service.

The first condition includes that the first indication information of the cell system broadcast message configuration is set to a “false” value and at least one SNPN supported by the cell supports emergency communication services.

That is to say, both the terminal device that supports the NPN function but is not in the SNPN mode and the terminal device that does not support the NPN function can reside in the SNPN cell and initiate the emergency communication service in a case that the first condition is satisfied.

Fifth manner: in a case that the first condition is satisfied, the first terminal device can initiate the emergency communication service, but the second terminal device cannot initiate the emergency communication service. What is different from the aforementioned second manner is that the first condition includes that: the first indication information configured by the cell system broadcast message is set to a value of “false”, at least one SNPN supported by the cell supports the emergency communication service, and third indication information configured by the cell system broadcast message allows the terminal device that supports the NPN function but not in the SNPN mode to initiate the emergency communication service through the SNPN.

That is to say, the terminal device that supports the NPN function but is not in the SNPN mode can reside in the SNPN cell and initiate the emergency communication service in a case that the first condition is satisfied. The terminal device that does not support the NPN function cannot initiate the emergency communication service through any SNPN network.

Sixth manner: in a case that the first condition is satisfied, the first terminal device can initiate the emergency communication service; in a case that the second condition is satisfied, the second terminal device can initiate the emergency communication service.

The second condition includes that the first indication information configured by the cell system broadcast message is set to a value of “false”, at least one SNPN supported by the cell supports the emergency communication service, and the second indication information configured by the cell system broadcast message allows the terminal device that does not support the NPN function to initiate the emergency communication service through the SNPN.

What is different from the aforementioned third manner is that the first condition includes that: the first indication information configured by the cell system broadcast message is set to a value of “false”, at least one SNPN supported by the cell supports the emergency communication service, and third indication information configured by the cell system broadcast message allows the terminal device that supports the NPN function but not in the SNPN mode to initiate the emergency communication service through the SNPN.

That is to say, the terminal device that supports the NPN function but is not in the SNPN mode can reside in the SNPN cell and initiate the emergency communication service in a case that the first condition is satisfied. The terminal device that does not support the NPN function can reside in the SNPN cell and initiate the emergency communication service in a case that the second condition is satisfied.

It should be noted that, in the aforementioned various manners, the usage of the first indication information is that: the first indication information configured by a cell system broadcast message is set to a value of “true”, the terminal device that supports the NPN function but is not in the SNPN mode and the terminal device that does not support the NPN function cannot reside in the cell, i.e., cannot accept any service in the cell.

In this example, the manner that the terminal device knows whether at least one SNPN network supported by the cell supports the emergency communication service is as follows.

The terminal device knows whether at least one SNPN network supported by the cell supports the emergency communication service from the cell system broadcast message, or acquires whether at least one SNPN network supported by the cell supports the emergency communication service through a default implementation. Exemplarily, the default implementation is, for example, that the terminal device knows whether at least one SNPN network supported by the cell supports the emergency communication service through history storage information of the terminal device or by attempting a registration process of the emergency communication on the SNPN network.

In this example, a control mechanism that controls the terminal device to receive the PWS service is as follows.

The terminal device supporting the NPN function but not in the SNPN mode or the terminal device that does not support the NPN function needs to monitor possible PWS update indication information through a paging channel as long as it can reside in the cell (for example, if the terminal device can initiate the emergency communication service in the cell according to any one of the first manner to the sixth manner, it is considered that the terminal device can reside in the cell), that is, the terminal device needs to accept the PWS service as long as the terminal device can reside in the cell. Further, the terminal device capable of accepting the PWS service needs to have the capability of supporting the PWS service reception.

### Second Example

In this example, both the conditions under which the terminal device accepts the emergency communication service and the conditions under which the terminal device accepts the PWS service are controlled. The terminal device may be controlled to accept the emergency communication service according to any one of the first manner to the sixth manner in the aforementioned first example. The manner of controlling the terminal device to accept the PWS service includes any one of the following manners.

First manner: neither the first terminal device nor the second terminal device can accept the PWS service in the SNPN cell.

That is, both the terminal device that supports the NPN function but is not in the SNPN mode and the terminal device that does not support the NPN function cannot accept the PWS service in the SNPN cell.

Second manner: in a case that a first condition is satisfied, the first terminal device can accept the PWS service, but the second terminal device cannot accept the PWS service. The first condition includes that: the first indication information configured by the cell system broadcast message is set to a value of “false”, or the first indication information configured by the cell system broadcast message is set to a value of “false” and at least one SNPN supported by the cell supports the PWS service.

That is to say, the terminal device that supports the NPN function but is not in the SNPN mode can reside in the SNPN cell and accept the PWS service in a case that the first condition is satisfied. The terminal device that does not support the NPN function cannot accept the PWS service in the SNPN cell.

Third manner: in a case that the first condition is satisfied, the first terminal device can accept the PWS service; in a case that the second condition is satisfied, the second terminal device can accept the PWS service.

The first condition includes that: the first indication information configured by the cell system broadcast message is set to a value of “false”, or the first indication information configured by the cell system broadcast message is set to a value of “false” and at least one SNPN supported by the cell supports the PWS service.

The second condition includes that: the first indication information configured by the cell system broadcast message is set to a value of “false” and second indication information configured by the cell system broadcast message allows the terminal device that does not support the NPN function to accept the PWS service through the SNPN network. Alternatively, the second condition includes that: the first indication information configured by the cell system broadcast message is set to a value of “false”, at least one SNPN supported by the cell supports the PWS service and second indication information configured by the cell system broadcast message allows the terminal device that does not support the NPN function to accept the PWS service through the SNPN network.

That is to say, the terminal device that supports the NPN function but is not in the SNPN mode can reside in the SNPN cell and accept the PWS service in a case that the first condition is satisfied. The terminal device that does not support the NPN function can reside in the SNPN cell and accept the PWS service in a case that the second condition is satisfied.

Fourth manner: both the first terminal device and the second terminal device can accept the PWS service in a case that the first condition is satisfied.

The first condition includes that: the first indication information configured by the cell system broadcast message is set to a value of “false”, or the first indication information configured by the cell system broadcast message is set to a value of “false” and at least one SNPN supported by the cell supports the PWS service.

That is, the terminal device that supports the NPN function but is not in the SNPN mode and the terminal device that does not support the NPN function can reside in the SNPN cell and accept the PWS service in a case that the first condition is satisfied.

Fifth manner: in a case that the first condition is satisfied, the first terminal device can accept the PWS service, and the second terminal device cannot accept the PWS service.

What is different from the aforementioned second manner is that the first condition includes that:

the first indication information configured by the cell system broadcast message is set to a value of “false” and third indication information configured by the cell system broadcast message allows the terminal device that supports the NPN function but is not in the SNPN mode to accept the PWS service through the SNPN network. Alternatively, the first condition includes that: the first indication information configured by the cell system broadcast message is set to a value of “false”, at least one SNPN supported by the cell supports the PWS service and third indication information configured by the cell system broadcast message allows the terminal device that supports the NPN function but is not in the SNPN mode to accept the PWS service through the SNPN network.

That is, the terminal device that supports the NPN function but is not in the SNPN mode can reside in the SNPN cell and accept the PWS service in a case that the first condition is satisfied. The terminal device that does not support the NPN function cannot accept the PWS service in the SNPN cell.

Sixth manner: in a case that the first condition is satisfied, the first terminal device can accept the PWS service; in a case that the second condition is satisfied, the second terminal device can accept the PWS service.

The second condition includes that: the first indication information configured by the cell system broadcast message is set to a value of “false” and second indication information configured by the cell system broadcast message allows the terminal device that does not support the NPN function to accept the PWS service through the SNPN network. Alternatively, the second condition includes that: the first indication information configured by the cell system broadcast message is set to a value of “false”, at least one SNPN supported by the cell supports the PWS service and second indication information configured by the cell system broadcast message allows the terminal device that does not support the NPN function to accept the PWS service through the SNPN network.

What is different from the aforementioned third manner is that the first condition includes that: the first indication information configured by the cell system broadcast message is set to a value of “false” and third indication information configured by the cell system broadcast message allows the terminal device that supports the NPN function but is not in the SNPN mode to accept the PWS service through the SNPN network. Alternatively, the first condition includes that: the first indication information configured by the cell system broadcast message is set to a value of “false”, at least one SNPN supported by the cell supports the PWS service and third indication information configured by the cell system broadcast message allows the terminal device that supports the NPN function but is not in the SNPN mode to accept the PWS service through the SNPN network.

That is to say, the terminal device that supports the NPN function but is not in the SNPN mode can reside in the SNPN cell and accept the PWS service in a case that the first condition is satisfied. The terminal device that does not support the NPN function can reside in the SNPN cell and accept the PWS service in a case that the second condition is satisfied.

It should be noted that, in the aforementioned various manners, the usage of the first indication information is that: the first indication information configured by a cell system broadcast message is set to a value of “true”, the terminal device that supports the NPN function but is not in the SNPN mode and the terminal device that does not support the NPN function cannot reside in the cell, i.e., cannot accept any service in the cell.

In this example, the manner that the terminal device knows whether at least one SNPN network supported by the cell supports the PWS service is as follows.

The terminal device knows whether at least one SNPN network supported by the cell supports the PWS service from the cell system broadcast message, or acquires whether at least one SNPN network supported by the cell supports the PWS service through a default implementation. Exemplarily, the default implementation is, for example, that the terminal device knows whether at least one SNPN network supported by the cell supports the PWS service by attempting to monitor PWS update indication information in a paging channel.

Optionally, in the aforementioned various embodiments, the terminal device determining whether to use the restricted service provided by the cell based on the network type supported by the cell may further include that: in a case that the cell supports a public network, the terminal device determines that it is capable of transmitting an emergency communication service message in the cell, and/or in a case that the cell supports the public network, where the cell supports a public network, the terminal device determines that it is capable of receiving a PWS service message in the cell. Exemplarily, the case that the cell supports the public network may include a case that the cell only supports the public network and a case that the cell supports the public network while supporting the NPN.

The specific arrangement and implementation of the embodiments of the present disclosure have been described above from different angles through a plurality of embodiments. With at least one of the above embodiments, the first terminal device that supports the NPN function but is not in a SNPN mode, and/or the second terminal device that does not support the NPN function can determine whether to use the restricted service provided by the cell based on a network type supported by the cell, and thus it is beneficial to controlling the terminal device with the specific type to use the restricted service in case of an allowance by the network.

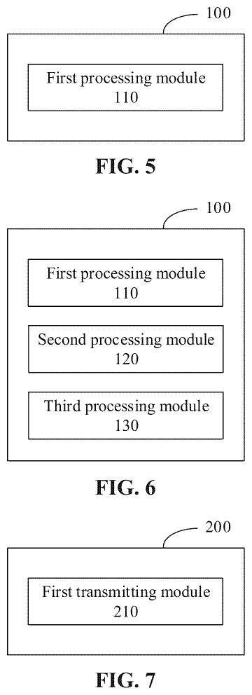

Corresponding to the processing method of at least one embodiment described above, an embodiment of the present disclosure further provides a terminal device 100, referring to FIG. 5, the terminal device 100 includes a first processing module.

The first processing module is configured to determine whether to use a restricted service provided by a cell based on a network type supported by the cell.

The terminal device includes a first terminal device that supports a NPN function but is not in a SNPN mode, and/or a second terminal device that does not support the NPN function.

Optionally, the restricted service includes an emergency communication service and/or a PWS service.

Optionally, the first processing module 110 is configured to:

in the case that the cell supports the SNPN, determine that it is incapable of transmitting an emergency communication service message in the cell.

Optionally, the first processing module 110 is configured to:

in the case that the cell supports the SNPN, determine whether it is capable of transmitting an emergency communication service message in the cell according to a preset condition.

Optionally, in a case that the terminal device is the first terminal device, the first processing module 110 is configured to:

in a case that a first condition is satisfied, determine that it is capable of transmitting the emergency communication service message in the cell.

Optionally, in a case that the terminal device 100 is the second terminal device, the first processing module 110 is configured to perform at least one of the following operations.

It is determined that it is incapable of transmitting the emergency communication service message in the cell in a case that a first condition is satisfied.

It is determined that it is capable of transmitting the emergency communication service message in the cell in a case that a second condition is satisfied.

It is determined that it is capable of transmitting the emergency communication service message in the cell in a case that the first condition is satisfied.

Optionally, the second condition includes that:

first indication information indicates that a current cell is not reserved for other usages;

at least one SNPN supported by the cell supports an emergency communication service; and

second indication information indicates that the second terminal device is

allowed to transmit the emergency communication service message through a SNPN.

Optionally, the first condition includes that:

first indication information indicates that a current cell is not reserved for other usages; and

at least one SNPN supported by the cell supports an emergency communication service.

Optionally, the first condition further includes that:

third indication information indicates that the first terminal device is allowed to

transmit the emergency communication service message through a SNPN.

Optionally, referring to FIG. 6, the terminal device 100 further includes a second processing module 120.

The second processing module 120 is configured to receive a PWS service message in the cell in a case that the terminal device is capable of transmitting the emergency communication service message in the cell.

Optionally, the first processing module 110 is configured to:

determine that it is incapable of receiving a PWS service message in the cell in a case that the cell supports a SNPN.

Optionally, the first processing module 110 is configured to:

determine whether it is capable of receiving a PWS service message in the cell according to a preset condition in a case that the cell supports a SNPN.

Optionally, in a case that the terminal device 100 is the first terminal device, the first processing module 110 is configured to:

determine that it is capable of receiving the PWS service message in the cell in a case that a third condition is satisfied.

Optionally, in a case that the terminal device 100 is the second terminal device, the first processing module 110 is configured to perform at least one of following operations.

It is determined that it is incapable of receiving the PWS service message in the cell in a case that a third condition is satisfied.

It is determined that it is capable of receiving the PWS service message in the cell in a case that a fourth condition is satisfied.

It is determined that it is capable of receiving the PWS service message in the cell in a case that the third condition is satisfied.

Optionally, the fourth condition includes that:

first indication information indicates that a current cell is not reserved for other usages; and

second indication information indicates that the second terminal device is allowed to receive the PWS service message through the SNPN.

Optionally, the fourth condition further includes that:

at least one SNPN supported by the cell supports a PWS service.

Optionally, the third condition includes that:

first indication information indicates that a current cell is not reserved for other usages.

Optionally, the third condition further includes that:

third indication information indicates that the first terminal device is allowed to receive the PWS service message through the SNPN.

Optionally, the third condition further includes that:

at least one SNPN supported by the cell supports a PWS service.

Optionally, the first indication information is configured by a cell system broadcast message.

Optionally, the second indication information is configured by a cell system broadcast message.

Optionally, the third indication information is configured by the cell system broadcast message.

In an exemplary manner, referring to FIG. 6, the terminal device 100 further includes a third processing module 130.

The third processing module 130 is configured to determine whether at least one SNPN supported by the cell supports the restricted service according to a received cell system broadcast message and/or historical storage information of the terminal device.

In another exemplary manner, referring to FIG. 6, the terminal device 100 further includes a third processing module 130.

The third processing module 130 is configured to determine whether at least one SNPN supported by the cell supports an emergency communication service by executing a registration process of the emergency communication service.

In another exemplary manner, referring to FIG. 6, the terminal device 100 further includes a third processing module 130.

The third processing module 130 is configured to determine whether at least one SNPN supported by the cell supports a PWS service by monitoring PWS update indication information.

The terminal device 100 of the embodiment of the present disclosure can realize the corresponding functions of the first core network element in the aforementioned method embodiments. The flows, functions, implementation manners and beneficial effects corresponding to each module (sub-module, unit or component, etc.) in the terminal device 100 can refer to the corresponding description in the aforementioned method embodiments, and will not be repeated herein. It should be noted that the functions described by each module (sub-module, unit or component, etc.) in the terminal device 100 of the embodiment of the present disclosure may be realized by different modules (sub-module, unit or component, etc.) or by a same module (sub-module, unit or component, etc.). For example, the first processing module and the second processing module may be different modules or a same module, and both of them may realize corresponding functions in the embodiments of the present disclosure. In addition, the communication module in the embodiments of the present disclosure may be realized by a transceiver of the device, and part of or all of the other modules may be realized by a processor of the device.

An embodiment of the present disclosure further provides a network device 200, referring to FIG. 7, the network device 200 includes a first transmitting module 210.

The first transmitting module 210 is configured to transmit first indication information to a terminal device, the first indication information is used for indicating the terminal device to determine whether a preset condition is satisfied, the preset condition is used for the terminal device to determine whether it is incapable of using a restricted service in a cell in a case that the cell supports a SNPN; and the terminal device includes a first terminal device that supports a NPN function but is not in a SNPN mode, and/or a second terminal device that does not support the NPN function.

Optionally, the first indication information is used for indicating whether a current cell is reserved for other usages.

Optionally, the first indication information is carried by a cell system broadcast message.

Optionally, the first indication information is used for indicating the first terminal device to determine whether a first condition and/or a third condition are/is satisfied.

The first condition is used for the first terminal device to determine whether it is capable of transmitting an emergency communication service message in the cell in a case that the cell supports the SNPN. The third condition is used for the first terminal device to determine whether it is capable of receiving a PWS service message in the cell in a case that the cell supports the SNPN.

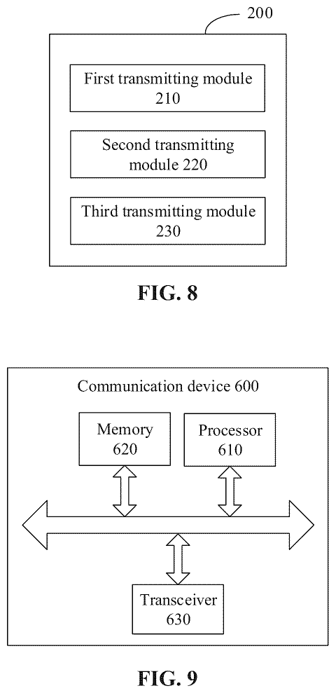

Optionally, referring to FIG. 8, the network device 200 further includes a second transmitting module 220.

The second transmitting module 220 is configured to transmit third indication information to the first terminal device, and the third indication information is used for indicating the first terminal device to determine whether the first condition and/or the third condition are/is satisfied.

Optionally, the third indication information is used for indicating whether the first terminal device is allowed to use the restricted service through the SNPN.

Optionally, the third indication information is carried by a cell system broadcast message.

Optionally, the first indication information is used for indicating the second terminal device to determine whether a first condition and/or a third condition are/is satisfied.

The first condition is used for the second terminal device to determine whether it is capable of transmitting an emergency communication service message in the cell in a case that the cell supports the SNPN. The third condition is used for the second terminal device to determine whether it is capable of receiving a PWS service message in the cell in a case that the cell supports the SNPN.

Optionally, referring to FIG. 8, the network device 200 further includes a third transmitting module 230.

The third transmitting module 230 is configured to transmit second indication information to the second terminal device, and the second indication information is used for indicating the second terminal device to determine whether a second condition and/or a fourth condition are/is satisfied.

The second condition is used for the second terminal device to determine whether it is capable of transmitting an emergency communication service message in the cell in a case that the cell supports the SNPN. The fourth condition is used for the second terminal device to determine whether it is capable of receiving a PWS service message in the cell in a case that the cell supports the SNPN.

Optionally, the second indication information is used for indicating whether the second terminal device is allowed to use the restricted service through the SNPN.

Optionally, the second indication information is carried by a cell system broadcast message.

The network device 200 of the embodiment of the present disclosure can realize the corresponding functions of the first core network element in the aforementioned method embodiments. The flows, functions, implementation manners and beneficial effects corresponding to each module (sub-module, unit or component, etc.) in the network device 200 can refer to the corresponding description in the aforementioned method embodiments, and will not be repeated herein. It should be noted that the functions described by each module (sub-module, unit or component, etc.) in the network device 200 of the embodiment of the present disclosure may be realized by different modules (sub-module, unit or component, etc.) or by a same module (sub-module, unit or component, etc.). For example, the first transmitting module and the second transmitting module may be different modules or a same module, and both of them may realize corresponding functions in the embodiments of the present disclosure. In addition, the communication module in the embodiments of the present disclosure may be realized by a transceiver of the device, and part of or all of the other modules may be realized by a processor of the device.

FIG. 9 is a schematic structural diagram of a communication device 600 according to an embodiment of the present disclosure. The communication device 600 includes a processor 610, and the processor 610 can call and run a computer program from a memory to implement the method in the embodiments of the present disclosure.

Optionally, the communication device 600 may further include a memory 620. The processor 610 may call and run a computer program from the memory 620 to implement the method in the embodiments of the present disclosure.

The memory 620 may be a separate device independent of the processor 610 or may be integrated into the processor 610.

Optionally, the communication device 600 may further include a transceiver 630. The processor 610 may control the transceiver 630 to communicate with other devices. Specifically, the transceiver 630 may transmit information or data to other devices or receive information or data transmitted by other devices.

The transceiver 630 may include a transmitter and a receiver. The transceiver 630 may further include antennas, and the number of the antennas may be one or more.

Optionally, the communication device 600 may be the terminal device of the embodiments of the present disclosure, and the communication device 600 may implement corresponding processes implemented by the terminal device in the various methods according to the embodiments of the present disclosure, which is not described repeatedly for the sake of simplicity.

Optionally, the communication device 600 may be the network device of the embodiments of the present disclosure, and the communication device 600 may implement corresponding processes implemented by the network device in the various methods according to the embodiments of the present disclosure, which is not described repeatedly for the sake of simplicity.

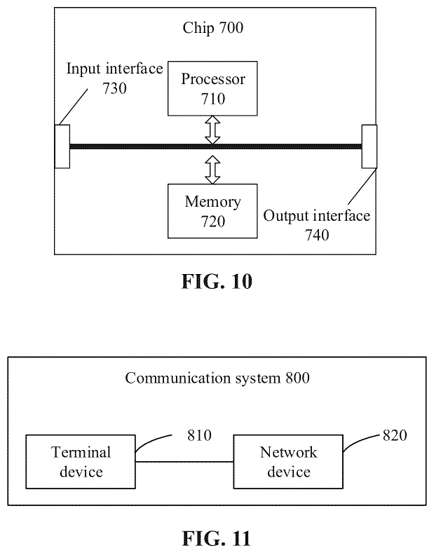

FIG. 10 is a schematic structural diagram of a chip 700 according to an embodiment of the present disclosure. The chip 700 includes a processor 710. The processor 710 can call and run computer programs from a memory to implement the method in the embodiments of the present disclosure.

Optionally, the chip 700 may further include a memory 720. The processor 710 can call and run the computer program from the memory 720 to implement the method in the embodiments of the present disclosure.

The memory 720 may be a separate device independent of the processor 710 or may be integrated into the processor 710.

Optionally, the chip 700 may further include an input interface 730. The processor 710 may control the input interface 730 to communicate with other devices or chips, and in particular to obtain information or data sent by other devices or chips.

Optionally, the chip 700 may further include an output interface 740. The processor 710 may control the output interface 740 to communicate with other devices or chips, and in particular to output information or data to other devices or chips.

Optionally, the chip may be applied to the terminal device in the embodiments of the present disclosure, and the chip may implement the corresponding processes implemented by the terminal device in various methods according to the embodiments of the present disclosure, which is not described repeatedly for the sake of brevity.

Optionally, the chip may be applied to the network device in the embodiments of the present disclosure, and the chip may implement the corresponding processes implemented by the network device in various methods according to the embodiments of the present disclosure, which is not described repeatedly for the sake of brevity.

It should be noted that the chip mentioned in the embodiments of the present disclosure may also be referred to as a system level chip, a system chip, a chip system or an on-chip system chip, etc.

The above processor may be a general purpose processor, a digital signal processor (DSPS), an application specific integrated circuit (ASIC), a field programmable gate array (FPGA) or other programmable logic devices, discrete gates or transistor logic devices, and discrete hardware components. The above general purpose processor may be a microprocessor or the processor may be any conventional processor or the like.

The memory in the embodiments of the present disclosure may be a volatile memory or a non-volatile memory, or may include both a volatile and a non-volatile memory. The non-volatile memory can be a read-only memory (ROM), a programmable ROM (PROM), an erasable PROM (EPROM), an electrically EPROM (EEPROM) or a flash memory. The volatile memory can be a random access memory (RAM).

It should be noted that the memory described above is exemplary, but not limiting. For example, the memory in the embodiments of the present disclosure may also be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM), etc. It is to be noted that the memory in the embodiments of the present disclosure is intended to include, but is not limited to, memories of these and any other suitable type.

FIG. 11 is a schematic block diagram of a communication system 800 according to an embodiment of the present disclosure. The communication system 800 includes a terminal device 810 and a network device 820.

The terminal device 810 may be used to implement corresponding functions implemented by the terminal device in the methods of the embodiments of the present disclosure, and the network device 820 may be used to implement corresponding functions implemented by the network device in the methods of the embodiments of the present disclosure, which is not described repeatedly for the sake of brevity.

In the above embodiments, it may be implemented in whole or in part by software, hardware, firmware or any combination thereof. When implemented by software, it can be implemented in whole or in part in the form of a computer program product. The computer program product includes one or more computer instructions. When the computer program instructions are loaded and executed on a computer, the processes or functions described in accordance with the embodiments of the present disclosure is generated in whole or in part. The computer may be a general purpose computer, a specific computer, a computer network, or other programmable devices. The computer instructions may be stored in a computer-readable storage medium or transmitted from one computer-readable storage medium to another computer-readable storage medium. For example, the computer instructions may be transmitted from one Web site, computer, server, or data center via wired (e.g. coaxial cable, optical fiber, Digital Subscriber Line (DSL)) or wireless (e.g. infrared, wireless, microwave, etc.) to another Web site, computer, server, or data center. The computer-readable storage medium may be any available medium accessible to a computer or a data storage device, such as a server containing one or more usable media integration, data center, etc. The available medium may be a magnetic medium (e.g. floppy disk, hard disk, magnetic tape), an optical medium (e.g. DVD), or a semiconductor medium (e.g. Solid State Disk (SSD)), etc.

It should be understood that in various embodiments of the present disclosure, the size of the sequence numbers of the above-mentioned processes does not mean an execution order, and the execution order of each process should be determined by its function and inherent logic, and should not be limited in any way to the implementation process of the embodiments of the present disclosure.

Those skilled in the art will clearly appreciate that, for convenience and conciseness of description, the specific operating processes of the above-described systems, devices and units may refer to the corresponding processes in the aforementioned embodiments corresponding to the methods and will not be elaborated herein.

The above is only the specific embodiments of the present disclosure, but the scope of protection of the present disclosure is not limited to this. Any modifications and variations that can be easily known by the person skilled in the art within the scope of protection of the present disclosure shall be covered in the scope of protection of the present disclosure. Therefore, the scope of protection of the present disclosure shall be subject to the scope of protection of the claims.

1. A method for processing a restricted service, comprising:
determining, by a terminal device, whether to use the restricted service provided by a cell based on a network type supported by the cell,
wherein the terminal device comprises a first terminal device that supports a Non-public Network (NPN) function but is not in a Stand-alone Non-public Network (SNPN) mode, and/or a second terminal device that does not support the NPN function.

2. The method of claim 1, wherein the restricted service comprises an emergency communication service and/or a Public Warning System (PWS) service.

3. The method of claim 1, wherein determining, by the terminal device, whether to use the restricted service provided by the cell based on the network type supported by the cell comprises:
in a case that the cell supports a SNPN, determining, by the terminal device, that it is incapable of transmitting an emergency communication service message in the cell.

4. The method of claim 1, wherein determining, by the terminal device, whether to use the restricted service provided by the cell based on the network type supported by the cell comprises:
in a case that the cell supports a SNPN, determining, by the terminal device, whether it is capable of transmitting an emergency communication service message in the cell according to a preset condition.

5. The method of claim 4, wherein determining, by the terminal device, whether it is capable of transmitting the emergency communication service message in the cell according to the preset condition comprises:
in a case that a first condition is satisfied, determining, by the first terminal device, that it is capable of transmitting the emergency communication service message in the cell.

6. The method of claim 4, wherein determining, by the terminal device, whether it is capable of transmitting the emergency communication service message in the cell according to the preset condition comprises at least one of following operations:
in a case that a first condition is satisfied, determining, by the second terminal device, that it is incapable of transmitting the emergency communication service message in the cell;
in a case that a second condition is satisfied, determining, by the second terminal device, that it is capable of transmitting the emergency communication service message in the cell; or
in a case that the first condition is satisfied, determining, by the second terminal device, that it is capable of transmitting the emergency communication service message in the cell.

7. The method of claim 6, wherein the second condition comprises that:
first indication information indicates that a current cell is not reserved for other usages;
at least one SNPN supported by the cell supports an emergency communication service; and
second indication information indicates that the second terminal device is allowed to transmit the emergency communication service message through a SNPN.

8. The method of claim 5, wherein the first condition comprises that:
first indication information indicates that a current cell is not reserved for other usages; and
at least one SNPN supported by the cell supports an emergency communication service.

9. The method of claim 8, wherein the first condition comprises that:
third indication information indicates that the first terminal device is allowed to transmit the emergency communication service message through a SNPN.

10. The method of claim 1, wherein determining, by the terminal device, whether to use the restricted service provided by the cell based on the network type supported by the cell comprises:
in a case that the cell supports a SNPN, determining, by the terminal device, that it is incapable of receiving a PWS service message in the cell.

11. A terminal device, comprising a processor and a memory for storing a computer program, wherein the processor calls and runs the computer program stored in the memory to cause the terminal device to:
determine whether to use a restricted service provided by a cell based on a network type supported by the cell,
wherein the terminal device comprises a first terminal device that supports a Non-public Network (NPN) function but is not in a Stand-alone Non-public Network (SNPN) mode, and/or a second terminal device that does not support the NPN function.

12. A network device, comprising a processor and a memory for storing a computer program, wherein the processor calls and runs the computer program stored in the memory to cause the network device to:
transmit first indication information to a terminal device, wherein the first indication information is used for indicating the terminal device to determine whether a preset condition is satisfied, the preset condition is used for the terminal device to determine whether it is incapable of using a restricted service in a cell in a case that the cell supports a Stand-alone Non-public Network (SNPN); and wherein the terminal device comprises a first terminal device that supports a Non-public Network (NPN) function but is not in a SNPN mode, and/or a second terminal device that does not support the NPN function.

13. The network device of claim 12, wherein the first indication information is used for indicating whether a current cell is reserved for other usages.

14. The network device of claim 12, wherein the first indication information is carried by a cell system broadcast message.

15. The network device of claim 12, wherein the first indication information is used for indicating the first terminal device to determine whether a first condition and/or a third condition are/is satisfied; and
wherein the first condition is used for the first terminal device to determine whether it is capable of transmitting an emergency communication service message in the cell in a case that the cell supports the SNPN, and the third condition is used for the first terminal device to determine whether it is capable of receiving a PWS service message in the cell in a case that the cell supports the SNPN.

16. The network device of claim 15, wherein the processor further causes the network device to:
transmit third indication information to the first terminal device, wherein the third indication information is used for indicating the first terminal device to determine whether the first condition and/or the third condition are/is satisfied;
wherein the third indication information is used for indicating whether the first terminal device is allowed to use the restricted service through the SNPN;
wherein the third indication information is carried by a cell system broadcast message.

17. The network device of claim 12, wherein the first indication information is used for indicating the second terminal device to determine whether a first condition and/or a third condition are/is satisfied; and
wherein the first condition is used for the second terminal device to determine whether it is capable of transmitting an emergency communication service message in the cell in a case that the cell supports the SNPN, and the third condition is used for the second terminal device to determine whether it is capable of receiving a PWS service message in the cell in a case that the cell supports the SNPN.

18. The network device of claim 12, wherein the processor further causes the network device to:
transmit second indication information to the second terminal device, wherein the second indication information is used for indicating the second terminal device to determine whether a second condition and/or a fourth condition are/is satisfied; and
wherein the second condition is used for the second terminal device to determine whether it is capable of transmitting an emergency communication service message in the cell in a case that the cell supports the SNPN, and the fourth condition is used for the second terminal device to determine whether it is capable of receiving a PWS service message in the cell in a case that the cell supports the SNPN.

19. The network device of claim 18, wherein the second indication information is used for indicating whether the second terminal device is allowed to use the restricted service through the SNPN.

20. The network device of claim 19, wherein the second indication information is carried by a cell system broadcast message.
